(19) United States
(12) Patent Application Publication
(10) Pub. No.: US 2025/0095233 A1
(43) Pub. Date: Mar. 20, 2025

(54) METHOD AND SYSTEM FOR GENERATING CUSTOM-FIT GARMENT PATTERNS AT SCALE

(71) Applicant: One to One Systems Inc., Dover, DE (US)

(72) Inventor: Julian Ortega, Brooklyn, NY (US)

(21) Appl. No.: 18/884,942

(22) Filed: Sep. 13, 2024

Related U.S. Application Data
(60) Provisional application No. 63/583,156, filed on Sep. 15, 2023.

(51) Int. Cl. G06T 11/00; G06T 17/00

(52) U.S. Cl. CPC G06T 11/001; G06T 17/00

(57) ABSTRACT

A system for generating custom-fit garment patterns at scale and methods for making and using the same. The system can create at least one three-dimensional body model for a selected custom-fit garment pattern based upon a body profile. Using the three-dimensional body model, the system can directly make one or more anthropometric measurements and can estimate any indirect measurements that cannot be directly measured. The system thereby can generate the selected custom-fit garment pattern based upon the body profile, which can consist of the anthropometric measurements for the three-dimensional body model and the estimated indirect measurements. The generated custom-fit garment pattern then can be visualized. Advantageously, the system can lay a technical foundation for a more sustainable and adaptive approach to garment production that is more computationally efficient than traditional computer-aided design, which can be integrated natively with advanced machine learning systems.

### CROSS-REFERENCE TO RELATED APPLICATIONS

This application claims the benefit of, and priority to, U.S. Provisional Application Ser. No. 63/583,156, filed on Sep. 15, 2023, the disclosure of which is hereby incorporated herein by reference in its entirety and for all purposes.

### FIELD

The present disclosure generally relates to garment pattern generation and more particularly, but not exclusively, to converting garment patterns into parametric sequence sets for generating one or more digitized and/or tagged garment patterns.

### BACKGROUND

Currently-available digital systems for making garment patterns have complex user interfaces that are difficult to use and have steep learning curves, which lead to low adoption and perpetuate outdated systems. Some of these systems comprise artificial intelligence-based (or AI-based) tools for transforming textual descriptions of garments into concept art. The concept art generated by these AI-based tools, however, are appealing images but have no direct application in actual garment pattern design.

These conventional digital pattern making systems likewise perpetuate use of outdated production systems in the garment supply chain. According to recent studies, fifty-five percent of all garments produced never make it into consumers' closets. Forty percent of the produced garments are overproduced; whereas, another thirty percent are returned, half of which are discarded. Profits in the garment industry therefore can increase by eliminating waste from mass production of ill-fitting garments with outdated standardized sizes.

In view of the foregoing, a need exists for an improved system and method for generating garment patterns that overcomes the aforementioned obstacles and deficiencies of currently-available pattern making systems.

### BRIEF DESCRIPTION OF THE FIGURES

FIG. 1 is a top-level flow chart illustrating an exemplary embodiment of a method for generating custom-fit garment patterns at scale.

FIG. 2 is a detail drawing illustrating an exemplary embodiment of a three-dimensional body model created by the method of FIG. 1.

FIG. 3A is a detailed flow chart illustrating an exemplary embodiment of creating the three-dimensional body model of FIG. 2.

FIG. 3B is a detailed flow chart illustrating an exemplary embodiment of making anthropometric measurements for the three-dimensional body model of FIG. 3A.

FIG. 3C is a detailed flow chart illustrating an exemplary embodiment of estimating indirect measurements for the three-dimensional body model of FIG. 3A.

FIG. 3D is a detailed flow chart illustrating an exemplary embodiment of generating the custom-fit garment pattern for the three-dimensional body model of FIG. 3A based upon the anthropometric measurements of FIG. 3B and/or the estimated indirect measurements of FIG. 3C.

FIG. 3E is a detailed flow chart illustrating an exemplary embodiment of visualizing the custom-fit garment pattern of FIG. 3D.

FIG. 4A is a top-level flow chart illustrating an exemplary alternative embodiment of the method of FIG. 1, wherein a body profile for a three-dimensional (or 3D) body model for a selected custom-fit garment pattern is provided.

FIG. 4B is a top-level flow chart illustrating an exemplary embodiment of a garment generation method based upon the body profile provided by the method of FIG. 4A.

FIG. 5 is a detailed flow chart illustrating another exemplary alternative embodiment of the method of FIG. 1, wherein the method is configured for providing the custom-fit garments at scale.

FIG. 6 is a detailed flow chart illustrating still another exemplary alternative embodiment of the method of FIG. 1, wherein the method is configured for providing a fit guarantee for non-custom-fit garments.

FIG. 7 is a detailed flow chart illustrating yet another exemplary alternative embodiment of the method of FIG. 1, wherein the method is configured for providing a sized pattern.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

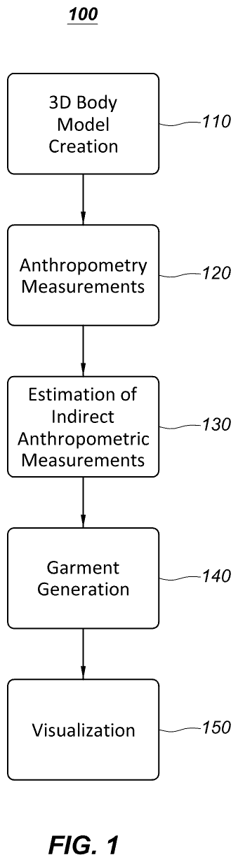

Since currently-available digital systems for making garment patterns perpetuate use of outdated production systems in the garment supply chain, have complex user interfaces and have steep learning curves, a system and method for making garment patterns that overcomes these shortcomings can prove desirable and provide a basis for a wide range of applications. This result can be achieved, according to selected embodiments disclosed herein, by an exemplary method 100 for generating custom-fit garment patterns at scale as illustrated in FIG. 1.

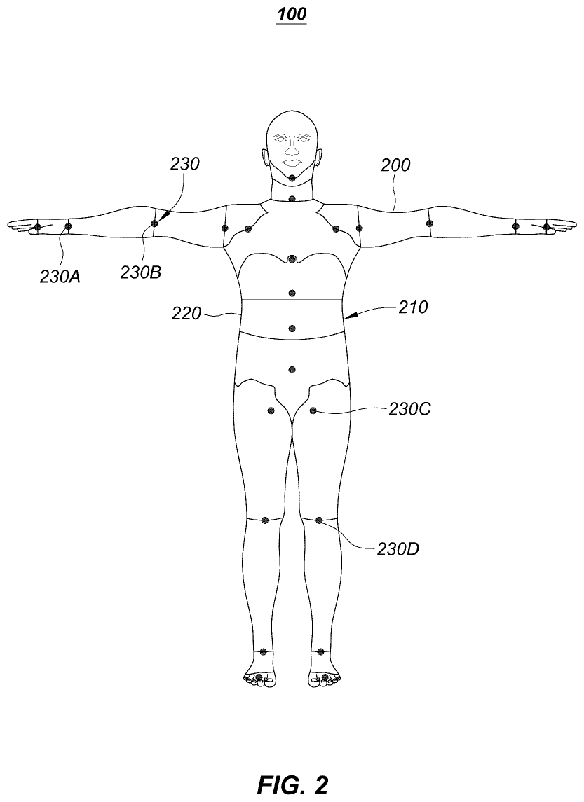

Turning to FIGS. 1 and 2, the method 100 is shown as including creating, at 110, at least one three-dimensional (or 3D) body model 200 for a selected custom-fit garment pattern based upon a body profile (or configuration). The body profile can comprise a plurality of body attributes associated with a body (not shown) of an intended wearer (not shown) of a garment (not shown) produced based upon the generated custom-fit garment pattern. Exemplary body attributes can include, but are not limited to, a gender, a set of one or more body measurements and/or a size estimation of the body of the intended wearer. The body measurements, for instance, can include a height, a waist circumference, an arm length and/or a leg length, of the body of the intended wearer without limitation. The body profile can be provided in any suitable manner such as via manual entry and/or a body scan of the body of the intended wearer, without limitation. The body scan, for instance, can be generated via a smart telephone device (not shown) or any other conventional body scanning system, which can output body scan data to be received by the method 100 as a part of the body profile. Manual entry of the body profile can be based upon measurements made by the intended wearer, a tailor or other user.

The three-dimensional body model 200, in selected embodiments, can comprise a deep learning model. The deep learning model, for instance, can comprise a Skinned Multi-Person Linear (or SMPL) model available from Max-Planck-Gesellschaft zur Förderung der Wissenschaften e. V., in Berlin, Germany. The SMPL model is a parametric three-dimensional (or 3D) human body model that describes both the shape and the pose of a body. The deep learning model can reconstruct a body shape of the intended wearer given a predetermined number of principal components (or beta parameters) and/or a predetermined number of parameters that define the pose of the body. The predetermined number of principal components can comprise any suitable number of principal components. Additionally and/or alternatively, the predetermined number of parameters that define the pose of the body can comprise any suitable number of parameters. The pose of a body, in selected embodiments, can comprise a standard (or neutral) A to T (or A/T) pose.

Exemplary predetermined number of principal components can be within a preselected range of between two and twenty principal components and preferably comprises ten principal components. Although shown and described herein with reference to the SMPL model for purposes of illustration only, the method 100 can be adapted to support any suitable body model type. The method 100, for example, can support the SMPL expressive (or SMPL-X) model or SMPL-H model both available from Max-Planck-Gesellschaft zur Förderung der Wissenschaften e. V., in Berlin, Germany, although one or more landmarks 230, joints and/or other body parts of the three-dimensional body model 200 may need to be redefined.

The method 100 can include, at 120, making one or more anthropometric (or direct) measurements for the three-dimensional body model 200. In selected embodiments, all of the anthropometric measurements for the three-dimensional body model 200 can be collected. A measurement type for each of the anthropometric measurements can be formulated or otherwise defined. The anthropometric measurements for the three-dimensional body model 200, for example, can comprise one or more predetermined measurements.

If any measurement cannot be directly inferred or otherwise determined from the three-dimensional body model 200, the measurement can be estimated via one or more anthropometric measurements, at 130. In other words, any measurement that is not directly anthropometric in nature, as in it can be directly measured as a distance between two points on the three-dimensional body model 200, can be estimated. These measurements can be estimated on a design-by-design basis when creating the action list. Each design can have its own action list. The action list can comprise a series of equations that output the points, lines and curves of the pattern diagram. Some of the variables in each equation are body measurements. When a 3D body is measured, the measurements are used as the variables in the action list of whichever pattern diagram is being generated.

Some of the measurements that cannot be directly determined from the three-dimensional body model 200 can comprise style-dependent measurements. Exemplary measurements that cannot be directly determined from the three-dimensional body model 200 can include, dart lengths, shirt lengths, jeans (or bottom) lengths and/or other style-specific measurements, such as upper ankle position, without limitation.

A dart measurement, for instance, cannot be calculated directly on the three-dimensional body model 200 and/or can be dependent on a style guideline and/or context of the dart measurement. Another example is the “jeans_bottom_width” measurement, which also can be style dependent. To estimate an indirect measurement, at 130, the method 100 can utilize a measurement context (not shown). The measurement context can comprise a measurement table and a list of one or more anthropometric measurements within the measurement table that can serve as factors for estimating the indirect measurement.

At 140, the method 100 can generate the selected custom-fit garment pattern based upon the body profile, which is comprised of the anthropometric measurements for the three-dimensional body model 200 and the estimated indirect measurements. The generated custom-fit garment pattern then can be visualized, at 150. Advantageously, the method 100 can lay a technical foundation for a more sustainable and adaptive approach to garment production that is more computationally efficient than traditional computer-aided design, which can be integrated natively with advanced machine learning systems (not shown). The method 100 further can be configured to generated garment patterns for any conceivable garment design, category and/or type. Additionally, the method 100 is computationally efficient for scaling production of garments in volume.

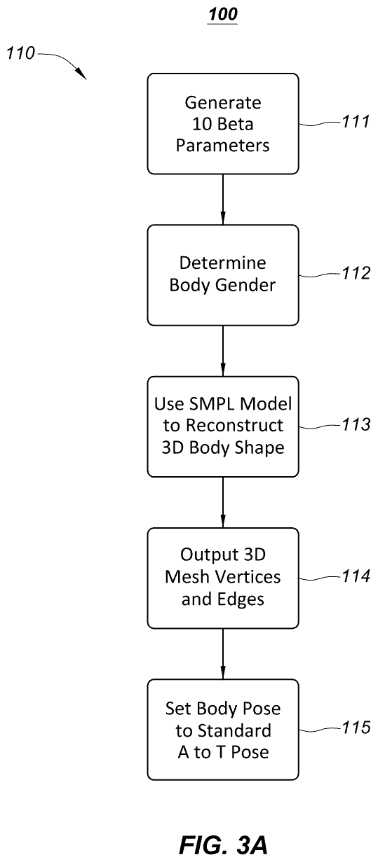

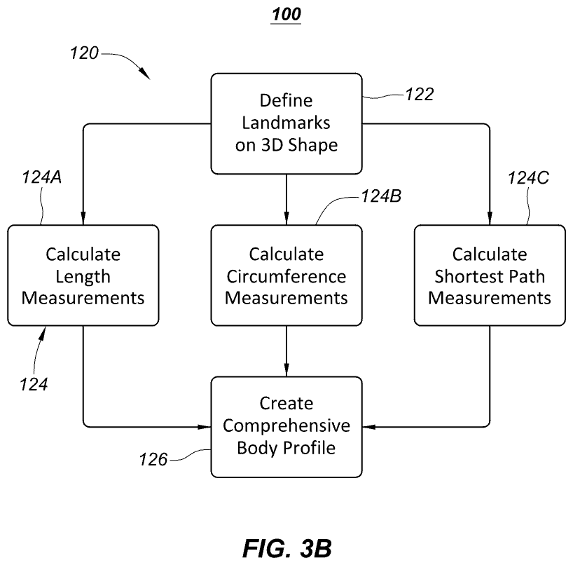

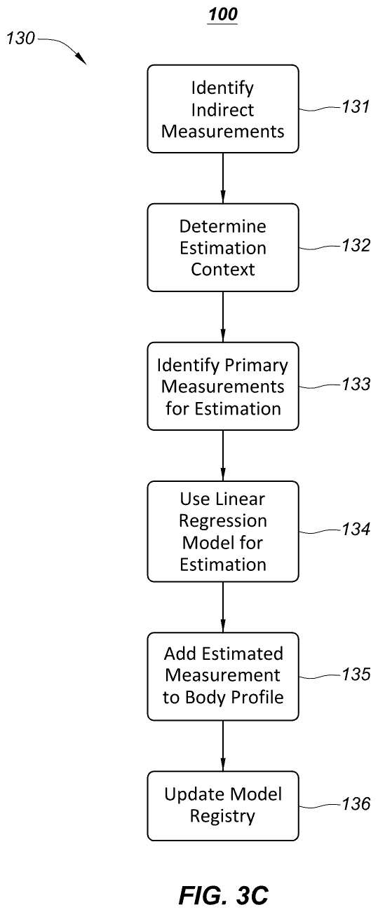

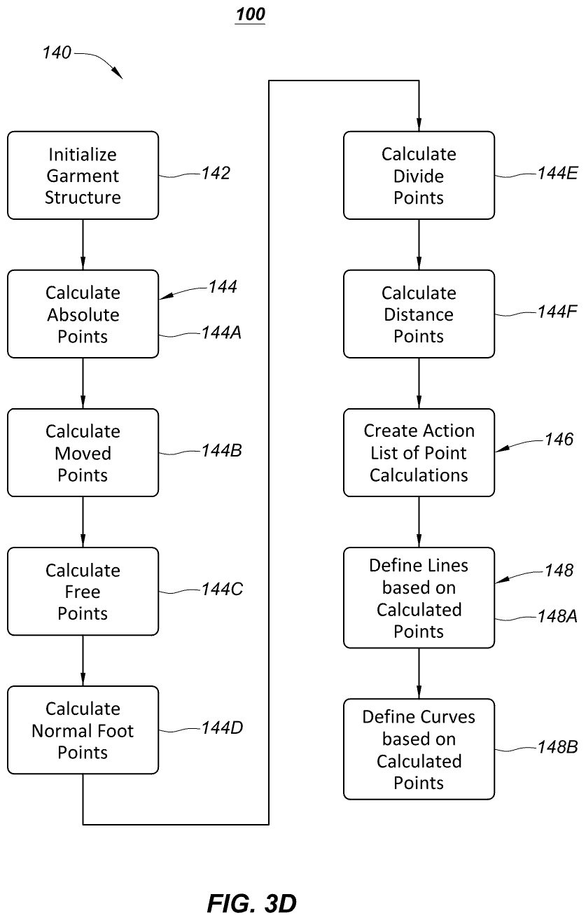

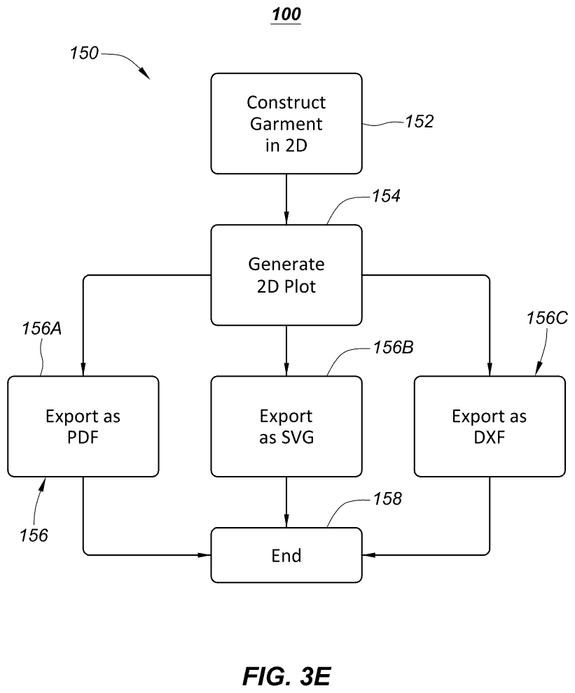

Each three-dimensional body model 200 can be created, at 110, in any suitable manner. The manners for creating the three-dimensional body models 200 can be uniform and/or different among the three-dimensional body models 200. An exemplary manner for creating the three-dimensional body model 200 is illustrated in FIG. 3A. Turning to FIG. 3A, the predetermined number of principal components can be generated, at 111. The principal components, for example, can be generated in the manner set forth in more detail above with reference to FIGS. 1 and 2. Once the principal components have been generated and the pose of the body is selected, a body gender of the three-dimensional body model 200 (shown in FIG. 2) can be determined, at 112, and/or a three-dimensional body shape 210 (shown in FIG. 2) of the three-dimensional body model 200 can be reconstructed, at 113.

At 114, an output of the three-dimensional body model 200 can include a set of vertices, faces and/or edges of the three-dimensional body shape 210. An output three-dimensional mesh 220 (shown in FIG. 2), in other words, can be generated, at 114, with the output three-dimensional mesh 220 including at least one mesh vertex and/or at least one mesh edge. The three-dimensional body model 200 can be disposed in a predetermined body model pose, at 115. The three-dimensional body model 200, for instance, can be fixed in a standard pose. Exemplary standard poses can include, but are not limited to, a standard A to T pose.

If a Skinned Multi-Person Linear (or SMPL) model is used, for example, the predetermined body model pose and the shape of the body of the intended wearer can be provided to the SMPL model. The shape of the body is determined by the predetermined number of principal components, at 111, that describe all body shapes in the SMPL training data, which spans all natural and common body shapes. As the predetermined number of principal components increases, the reconstruction error of the body shape should decrease. The SMPL model likewise can simulate twenty-four body joints. Each joint can have a position (or coordinate) and an orientation, such as pitch, yaw and/or roll, which consist of all of the six degrees of movement. The predetermined body model pose of the body thereby can be formulated as the six degrees of freedom for each body joint.

Additionally and/or alternatively, the SMPL model can utilize the predetermined body model pose and the shape of the body of the intended wearer to produce a mesh, at 114, with vertices and edges that can be rigged to a human skeleton as the term “skeleton” is used in computer vision. Since two different body shapes can be associated with a selected skeleton, the body shape preferably corresponds to the input parameters, not directly to the skeleton. The SMPL model, in selected embodiments, can be trained using a CAESER dataset of scanned three-dimensional (or 3D) human body models, as available from SAE International in Warrendale, Pennsylvania, for reconstructing the shape and pose of the human bodies. Stated somewhat differently, the SMPL model can comprise a pretrained model on the CAESER dataset. The SMPL model can produce a 3D mesh with 6890 vertices with each vertex corresponding to a different body part as shown in FIG. 2. SMPL models likewise can be provided for male, female and neutral genders.

Each anthropometric measurement can be made, at 120 (shown in FIG. 1), in any suitable manner. The manners for making the anthropometric measurements can be uniform and/or different among the anthropometric measurements. An exemplary manner for making one or more anthropometric measurements, at 120, is illustrated in FIG. 3B.

FIG. 3B, for example, shows that one or more landmarks 230 (shown in FIG. 2) can be defined, at 122, on the three-dimensional body shape 210 (shown in FIG. 2) of the three-dimensional body model 200 (shown in FIG. 2). In selected embodiments, the landmarks 230 can comprise one or more predetermined landmarks 230. Each landmark 230 is a labeled 3D coordinate. In selected embodiments, a landmark 230 can be defined as a labeled index in the 6890 vertices of the SMPL model, which vertices correspond to a known position on the body. For example, “nape” can be defined as the index in the vertices list which corresponds to the nape. New landmarks 230 can be defined by uploading any SMPL 3D visualization (with any shape and pose), finding the index of the coordinate on the body to be specified and labeling the coordinate.

The landmarks 230 advantageously can be utilized for calculating or otherwise determining one or more measurements associated with the three-dimensional body shape 210, at 124. A length measurement can comprise a Euclidean distance between two landmarks 230. An exemplary length measurement can be performed, at 124A, by defining a first preselected landmark 230A (shown in FIG. 2) and a second preselected landmark 230B (shown in FIG. 2) between which a length is to be calculated or otherwise measured and calculating the Euclidean distance between the first and second predetermined landmarks 230A, 230B. In selected embodiments, the length measurement may not be “rigid” because the length measurement may not consider the body. A height measurement, for example, can be calculated between a heels landmark 230 and a top_head landmark 230 and/or can cross the rigid body.

Additionally and/or alternatively, a circumference measurement can be calculated, at 124B. The circumference measurement can be defined by one or two landmarks 230, two joints and a corresponding body part. An exemplary circumference measurement can be performed by calculating an origin of a plane as a mean position of the two landmarks 230 (if there is only one landmark 230, that is the plane_origin). A normal vector to the plane can be calculated as a difference between the two joint positions. The normal vector can define an orientation of the plane. An intersection of the plane with body mesh can be identified. In selected embodiments, the intersection can occur at one or more segments of vertices of the mesh in which the plane intersects. All segments by the body part then can be filtered. Stated somewhat differently, all vertices that coincide in the body part can be filtered.

A convex hull algorithm can be applied to close the segment around the rigid body, returning a list of coordinates that can consist of the circumference path. A sum of adjacent coordinates distance in the list can be calculated to recover the total circumference measurement. For example, a waist_circumference measurement can be defined by the belly_button and back_belly_button landmarks 230 and with the pelvis and spine3 joints. The waist_circumference measurement can correspond to the body part (or segment) between the hips and the spine. The circumference measurement, in selected embodiments, can comprise a length of the circumference between two landmarks or other points of the three-dimensional body shape 210 and/or can be represented as a ring overlaid on a predetermined surface of the three-dimensional body shape 210. If the circumference measurement is based upon a single landmark, the landmark can be the plane origin.

A shortest path measurement optionally can be calculated, at 124C, as a shortest distance between a first predetermined landmark 230C (shown in FIG. 2) and a second predetermined landmark 230D (shown in FIG. 2). The first and second predetermined landmarks 230C, 230D used in the shortest path measurement calculation, at 124C, can be the same as, and/or different from, the first and second preselected landmarks 230A, 230B used in the length measurement calculation, at 124A. Stated somewhat differently, the shortest path measurement calculation, at 124C, can provide a shortest distance between two points on a rigid body and can be defined by a list of vertices, which constitute the shortest route to pass through.

In selected embodiments, Dijkstra's algorithm can be utilized for determining the shortest route between the two defined points. The A* search algorithm and/or the D* Lite algorithm optionally can be utilized if Dijkstra's algorithm produces a shortest path with jagged edges. For example, a shortest path measurement can be calculated, at 124C, for a nape_to_waist distance that is defined between the back_nape landmark 230 and the back_belly_button landmark 230. The back_belly_button landmark 230 can reside on the waist circumference.

In selected embodiments, a new measurement can be calculated by defining a type of measurement desired with the corresponding landmarks 230, joints and body parts and then defining the landmarks 230 to be used for the measurement. If no landmarks 230 exist, the new measurement can be calculated, for instance, by defining the new measurement using a SMPL visualization.

The measurements associated with the three-dimensional body shape 210, at 124, can be utilized to create a comprehensive body profile, at 126. Stated somewhat differently, the measurements associated with the three-dimensional body shape 210, at 124, can be used for creating a body profile that encompasses anthropometric data needed to create the selected custom-fit garment pattern. The anthropometric data associated with the measurements associated with the three-dimensional body shape 210, at 124, preferably comprises all of the anthropometric data needed to create the selected custom-fit garment pattern.

The indirect measurements can be estimated, at 130 (shown in FIG. 1), in any suitable manner. The manners for estimating the indirect measurements, at 130, can be uniform and/or different among the indirect measurements. An exemplary manner for estimating the indirect measurements, at 130, is illustrated in FIG. 3C.

Turning to FIG. 3C, the one or more indirect measurements to be estimated can be identified, at 131. A set of predetermined indirect measurements, in selected embodiments, can be stored in a model registry file (not shown). Each predetermined indirect measurement in the model registry file can be defined by a context table (not shown) from which the predetermined indirect measurement can be derived. The context table optionally can include one or more leading factors that can be used to estimate the predetermined indirect measurement.

For each of the indirect measurements identified, at 131, the method 100 can determine an estimation context, at 132, and/or identify one or more primary measurements for estimating the identified indirect measurement, at 133. For example, if the body profile is associated with a selected body type of a tall woman intended for high fashion, the method 100 can utilize the primary measurements associated with the selected body type. The primary measurements associated with the selected body type, in selected embodiments, can be provided in a table (not shown) of primary measurements. To estimate a clothing pressure for the tall woman, for example, the method 100 can use a bust, a height, and/or a neck size as the primary measurements.

The method 100 advantageously can utilize a linear regression model, at 134, for estimating each indirect measurement. Additionally and/or alternatively, the method 100 can maintain the model registry file. As illustrated in FIG. 3C, for example, the method 100 can add at least one of the estimated indirect measurements to the body profile, at 135. Additionally and/or alternatively, model registry file can be updated, at 136, to include one or more of the estimated indirect measurements.

The custom-fit garment pattern can be generated, at 140 (shown in FIG. 1), in any suitable manner. In selected embodiments, the custom-fit garment pattern can be structured from points, lines and/or curves. One or more of the points can be built sequentially. In other words, the points can comprise a sequence of points. The method 100 advantageously can support several point types. Each point can be determined by a predetermined function, and/or a value of the point can be determined relative to at least one preceding point in the sequence, the constructed style, and/or the body measurements. A point, for example, can be determined by a function, which can include a point type and one or more other arguments. Exemplary arguments can comprise a body measure and/or at least one style parameter. In selected embodiments, at least one of the body measurements can be style-dependent.

An exemplary manner for generating the custom-fit garment pattern, at 140, is illustrated in FIG. 3D. Turning to FIG. 3D, a structure of the custom-fit garment pattern can be initialized, at 142. The structure of the custom-fit garment pattern, once initialized, can be formed by calculating the points, lines and/or curves, at 144. As shown in FIG. 3D, one or more points can be calculated, at 144. The method 100, for example, can calculate at least one absolute point that comprises a coordinate with fixed value, at 144A. One or more moved points each comprising a coordinate shifted in any direction relative to another point can be calculated, at 144B, and/or one or more free points that comprise a respective coordinate found by an optimization function, being fixed at a distance from another point and coinciding with a line, can be calculated, at 144C.

Additionally and/or alternatively, the method 100, at 144D, can calculate at least one normal foot point, which can comprise a point that is based on two given points, a ratio, and a distance along a normal (or perpendicular) direction to the line segment connecting the two given points. The method 100 optionally can calculate, at 144E, one or more divide points each comprising a point residing on a line connecting two points at a given ratio. One or more distance points that comprise a new point at a specified distance from a given point and at a specific angle relative to the given point can be calculated, at 144F. Although shown and described as calculating only various types of points with reference to FIG. 3D for purposes of illustration only, the method 100 can form the structure of the custom-fit garment pattern by calculating one or more of lines and/or curves, at 144, without limitation.

In selected embodiments, the points can be calculated, at 144, in a recursive manner. An action list of the point calculations can be created, at 146. The action list can comprise a set of points defined sequentially that define all of the data needed to construct the custom-fit garment. Based upon the calculated points, at 144, the lines and/or curves can be divided into one or more types, at 148. The lines, in other words, can be divided into one or more line types, and/or the curves can be divided into one or more curve types based upon the calculated points. As shown in FIG. 3D, for example, at least one line can be defined based upon the calculated points, at 148A, and at least one curve can be defined based upon the calculated points, at 148B. Advantageously, the generated custom-fit garment pattern can comprise a set of lines and curves that define a cutting pattern of the garment from the textile.

The generated custom-fit garment pattern can be visualized, at 150 (shown in FIG. 1), in any suitable manner. The manners for generating custom-fit garment patterns can be visualized, at 150, can be uniform and/or different among the custom-fit garment patterns. In selected embodiments, visualization of the custom-fit garment pattern, at 150, can comprise a visualization of a two-dimensional blueprint of the garment pattern.

Additionally and/or alternatively, visualization of the selected measurements of the three-dimensional body shape 210 can include plotting the selected measurements. The selected measurements can include, but are not limited to, a length measurement of three-dimensional body shape 210, a circumference measurement of the three-dimensional body shape 210 and/or a shortest path measurement of the three-dimensional body shape 210 each being provided in the manner set forth in more detail above with reference to FIG. 3B. In selected embodiments, the selected measurements can be plotted as a list of points on the three-dimensional mesh 220.

An exemplary manner for visualizing the generated custom-fit garment pattern, at 150, is illustrated in FIG. 3E. As shown in FIG. 3E, the generated custom-fit garment pattern can be constructed, at 152, in two dimensions. A two-dimensional (or 2D) plot of the constructed custom-fit garment pattern can be generated, at 154. If visualized as a two-dimensional (or 2D) plot, the constructed custom-fit garment pattern, at 156, can be exported or otherwise provided in a predetermined visualization format.

The constructed custom-fit garment pattern, for instance, can be exported or otherwise provided in a Portable Document Format (or .PDF) format, at 156A. At 156B, the constructed custom-fit garment pattern can be exported or otherwise provided in a Scalable Vector Graphics (or .SVG) format. Additionally and/or alternatively, the constructed custom-fit garment pattern can be exported or otherwise provided in a Drawing Exchange Format (or .DXF), at 156C.

Although shown and described as being provided in selected formats with reference to FIG. 3E for purposes of illustration only, the constructed custom-fit garment pattern can be exported or otherwise provided in any suitable format. An exemplary suitable format can be an Extensible data Format (or XDF) format, without limitation.

Exemplary other suitable formats can include, but are not limited to, a Portable Network Graphic (or PNG) format. If provided in the Portable Document Format (or .PDF) format, the constructed custom-fit garment pattern can be provided in a smaller scale than intended. The scaling of the constructed custom-fit garment pattern can be adjusted by generating the constructed custom-fit garment pattern in the PNG format. A number of dots per inch (or DPI) for the generated custom-fit garment pattern can be calculated, and the generated custom-fit garment pattern can be converted into the .PDF format in a manner that preserves the calculated number of dots per inch for the generated custom-fit garment pattern. The method 100 can end, at 158.

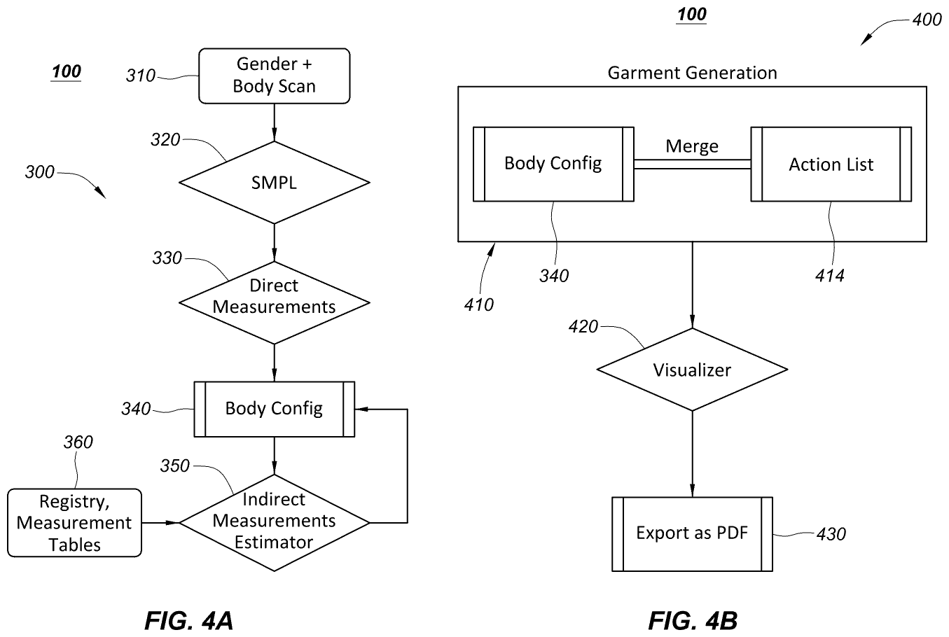

An alternative embodiment of the method 100 is illustrated in FIGS. 4A-B. Turning to FIG. 4A, an exemplary method 300 for providing a body profile (or configuration) for a three-dimensional (or 3D) body model 200 (shown in FIG. 2) for a selected custom-fit garment pattern is shown. The method 300 can include, at 310, selecting a gender of a body (not shown) of an intended wearer (not shown) of a garment (not shown) produced based upon the generated custom-fit garment pattern and generating a predetermined number of principal components, such as beta parameters, for a body shape of the intended wearer. The principal components alternatively can be uniformly generated. In selected embodiments, the gender of the body of the intended wearer can be selected in the manner discussed in more detail, at 112, with reference to FIGS. 1 and 3A, and/or the principal components for the body shape of the intended wearer can be generated in the manner discussed in more detail, at 111, with reference to FIGS. 1 and 3A.

In selected embodiments, the method 300 can receive a body scan (or input measurements) of the intended wearer. The body scan of the intended wearer can be received in any suitable automated and/or manual manner. Stated somewhat differently, the method 300, can receive a scan of the body of the intended wearer and/or can directly receive one or more measurements the body of the intended wearer. The body measurements, for instance, can include a height, a waist circumference, an arm length and/or a leg length, of the body of the intended wearer without limitation. The body scan, for instance, can be generated via a smart telephone device (not shown) or any other conventional body scanning system, which can output body scan data to be received by the method 300. Manual entry of the body profile can be based upon measurements made by the intended wearer, a tailor or other user. Once the gender and the body scan of the intended wearer have been received, a three-dimensional body shape 210 (shown in FIG. 2) of the three-dimensional (or 3D) body model 200 can be reconstructed, at 320.

The three-dimensional body shape 210 of the three-dimensional body model 200 can be reconstructed, at 320, for example, in the manner discussed in more detail, at 113, with reference to FIGS. 1 and 3A. As illustrated in FIG. 4A, the three-dimensional body model 200 can comprise a Skinned Multi-Person Linear (or SMPL) model. In selected embodiments, a pose for the three-dimensional body model 200 can be generated. The pose for the three-dimensional body model 200 can be generated in the manner discussed in more detail, at 115, with reference to FIGS. 1 and 3A. For instance, the pose for the three-dimensional body model 200 can be set the pose to a standard A-pose or a standard T-pose. Other poses optionally can be achieved using a set of twenty-four joint parameters with six degrees of freedom. In selected embodiments, an entire set of parameters can be inferred to the three-dimensional body model 200, and a three-dimensional mesh 220 (shown in FIG. 2) can be generated. The three-dimensional mesh 220 can comprise a set of 6890 coordinates of vertices, which can make a 3D body structure of the three-dimensional body model 200. Each vertex can correspond with a predetermined body part.

The method 300 can include, at 330, making one or more measurements of the three-dimensional body model 200. The measurements of the three-dimensional body model 200 can be made in any suitable manner including in the manner discussed in more detail, at 112, with reference to FIGS. 1 and 3B. A body profile (or configuration) for the three-dimensional (or 3D) body model 200 can be generated, at 340.

If any measurement cannot be directly inferred or otherwise determined from the three-dimensional body model 200, the measurement can be estimated via one or more anthropometric measurements, at 350. One or more indirect measurements can be estimated, at 350, in any suitable manner, including in the manner discussed in more detail, at 130, with reference to FIGS. 1 and 3C.

A set of predetermined indirect measurements, in selected embodiments, can be stored in a model registry file, at 360. In selected embodiments, the model registry file can be a text (or .TXT) file that contains the context table of the estimated indirect measurements and the leading factors. After calculating the estimator for the indirect measurements, the constants of the estimator can be stored in the model registry file to avoid training the estimator each time. A linear regression estimator (not shown) can be utilized with the number of constants to be saved being equal to the number of leading factors needed for the estimation. Each of the indirect measurements to be estimated, at 350, can be defined in the model registry file. Each predetermined indirect measurement in the model registry file can be defined by a context table (not shown) from which the predetermined indirect measurement can be derived. The context table optionally can include one or more leading factors that can be used to estimate the predetermined indirect measurement.

The method 300 advantageously can utilize a linear regression model for estimating each of the indirect measurements. In a preferred embodiment, each coefficient of the linear regression model can comprise a positive value to help avoid any negative estimates for the indirect measurements, which negative estimates are not physically practical. The linear regression model can be obtained in any suitable manner. For example, if the model registry file includes linear regression coefficients for estimating one or more selected indirect measurements, the method 300 can load a linear regression model with the linear regression coefficients from the model registry file. The model registry file can include the linear regression coefficients for estimating the selected indirect measurements based upon at least one prior estimation of the selected indirect measurements.

Alternatively, if the model registry file includes linear regression coefficients for estimating the selected indirect measurements, the method 300 can load the context table for the selected indirect measurements and extract at least one of the leading factors for estimating the selected indirect measurements. The extracted leading factors can comprise training data for the linear regression model, and/or a column of the selected indirect measurements can be utilized as the target column. A linear regression model (not shown) can be trained with the factors as inputs and can output the estimated measurements, which can comprise a target column in the context table. The training data and the target column can be utilized to train the linear regression model. The method 300 can update the model registry file with any coefficients generated during the training of the linear regression model to, for instance, avoid any redundant re-training of the linear regression model when generating future custom-fit garment patterns at scale.

Based upon the trained linear regression model, the selected indirect measurements can be estimated, at 350, and the body profile for the three-dimensional body model 200 can be updated, at 340.

An exemplary garment generation method 400 is illustrated in FIG. 4B. As shown in FIG. 4B, the garment generation method 400 can utilize the updated body profile (or configuration) provided via the method 300 (shown in FIG. 4A). The updated body profile can include the anthropometric measurements and/or the estimated indirect measurements for generating one or more custom-fit garment patterns. Stated somewhat differently, the garment generation method 400, at 410, can generate the selected custom-fit garment pattern based upon the body profile, at 340, which can comprise the anthropometric measurements for the three-dimensional body model 200 and the estimated indirect measurements in the manner discussed in more detail, at 140, with reference to FIGS. 1 and 3D.

Each custom-fit garment pattern can comprise a template that can be defined by one or more points and one or more curves and/or lines that are fitted on the points. In the action list, a position of each point can be described as a function with arguments, wherein the function can comprise a set of the operations to be performed on the point based upon the arguments. The arguments of each point could be any combination of body measurements, previous point values and/or other style dependent factors, without limitation.

In selected embodiments, the garment generation method 400, at 410, can create an action list of point calculations, at 414, for example, in the manner discussed in more detail, at 146, with reference to FIGS. 1 and 3D. The action list can fully describe a logical framework for creating the custom-fit garment pattern, which can be used to fabricate a physical garment. One or more control points optionally can be added to the action list to help fully describe the language instructions. The point calculations can be performed in a recursive manner and/or sequential manner. When the point calculations are performed in a recursive manner, each point can be dependent on a correct definition of one or more previous points.

The action list can be read beginning with a starting point and incrementing through the remaining points associated with the action list for point calculations that are performed in a sequential manner. The sequential manner permits a chain of point calculations to be performed in a predetermined sequence. Stated somewhat differently, all points in the predetermined sequence are chained together such that accessing a later point can solve all the related points in the chain. In selected embodiments, the predetermined sequence of points should be properly defined and all measurement parameters available for finding a solution to the sequence of points.

In the manner discussed in more detail above with reference to FIG. 3D, the points of the custom-fit garment pattern can be associated with one or more point types (or point functions). An exemplary point type associated with the points can comprise an absolute point type. A point that is associated with the absolute point type can be directly defined by the x, y coordinates of the point. Another exemplary point type associated with the points can comprise a move point type. The move point type can move the point by a predetermined distance (or magnitude) in a specified direction relative to an initial point location and can return a new point location of the point. Exemplary specified directions associated with the move point type can include, but are not limited to, a up direction, a down direction, a left direction and a right direction.

A point that is associated with a free point type can comprise a point that is disposed on a line formed between a first point and a second point and that is positioned by a predetermined distance from the first point. The free point type, in other words, can be an equivalent to an intersection between a circle being centered around a center point and having a radius that is equal to the predetermined distance and a line that passes through the first and second points. A line segment is formed between the first and second points and can continue to be lengthened until the line segment intersects the circle twice. Stated somewhat differently, the intersection of the line segment can be lengthened until it intersects with the circle once, and the intersection point is the point of interest.

Another point type can include a Normal Foot point type. The Normal Foot point type can comprise a projection of a projected point on a line segment that is defined by first and second base points. An error can result if no projection on the line segment exist. A divide point type can be defined by dividing a line segment formed between first and second points into a predetermined ratio and returning a third point that results from the division of the line segment. Additionally and/or alternatively, a normal point type can be calculated as a point that is offset from a line segment that is formed between first and second base points by a predetermined distance that is normal to the line segment and formed at a predetermined ratio along the line segment.

A Distance Point point type can be calculated as a new point that is disposed at a preselected distance and angle from a selected point. The method 400 can calculate an Intersection Point point type by finding an intersection point between a first line segment formed between first and second points and a second line segment formed between third and fourth points. In selected embodiments, a Project to Curve point type can comprise a point projected onto a curve that is represented as a series of points and can return a closest point among the series of points. A SquareAcross point type can be calculated as an intersection between a first line that passes through a point and a second line (or curve) that has an infinite length.

In selected embodiments, the point definitions can be globally registered OmegaConf resolvers, each of which comprise Yet Another Markup Language (or YAML)-based hierarchical configuration system. The template form and the body config can be defined as OmegaConf DictConfig instances. The DictConfig instances can be merged, and, when a points value is accessed, the solver can be run with the entire template being solved simultaneously.

With regard to curves, external lines can be differentiated from reference lines. External lines, for example, can form a border of the selected custom-fit garment pattern; whereas, a reference line can comprise any line other than an external line that can be utilized in construction of the selected custom-fit garment pattern. Exemplary reference lines can include cutting lines, lines that define constraints and/or symmetry lines, without limitation.

Each of the external lines and the reference lines can be associated with a predetermined line type. The external lines and the reference lines, for example, can be associated with a LineString line type. The LineString line type can comprise a set of sequential points that define a set of straight lines that pass through all of the points. A CubicSpline line type can generate an open cubic interpolating spline that passes through a sequence or other set of control points. The open cubic interpolating spline can comprise a smooth curve that is defined piecewise by segments associated with cubic polynomials, which can help to ensure smooth transitions between the segments. Advantageously, a direction of the control points in the sequence of the CubicSpline line type is of no importance.

Additionally and/or alternatively, the external lines and the reference lines can be associated with an Armscye line type. The Armscye line type can be defined by nine points P₁, P₂, P₃, P₄, P₅, P₆, P₇, P₈, P₉ being arranged sequentially in a counterclockwise direction. In selected embodiments, the nine points P₁, P₂, P₃, P₄, P₅, P₆, P₇, P₈, P₉ can be divided into four quadrants. Exemplary quadrants can include a first quadrant comprising a first set of three selected points P₁, P₂, P₃, a second quadrant comprising a second set of three selected points P₃, P₄, P₅, a third quadrant comprising a third set of three selected points P₅, P₆, P₇ and a fourth quadrant comprising a fourth set of three selected points P₇, P₈, P₉, without limitation. In each quadrant, a Bézier curve can be constructed. The Bézier curve can include a middle point disposed between two end points, wherein the end points can serve as edges of the Bézier curve and the middle point can act as a control point that shapes the Bézier curve. The Armscye line type advantageously can provide an accurate Armscye curve relative to a reference image with the least number of points. In selected embodiments, any inaccuracies in the stitching of the four quadrant Bezier curves can result in a jagged line, which could be mitigated by resampling and/or smoothing methods.

Once generated, the selected custom-fit garment pattern can be visualized, at 420, and/or exported, at 430. The selected custom-fit garment pattern can be visualized, at 420, in any suitable manner, including in the manner discussed in more detail, at 150, with reference to FIGS. 1 and 3E. Additionally and/or alternatively, the selected custom-fit garment pattern can be exported, at 430, in any suitable manner, including in the manner discussed in more detail, at 156, with reference to FIG. 3E. Although shown in FIG. 4B as being exported in a Portable Document Format (or .PDF) format for purposes of illustration only, the selected custom-fit garment pattern can be exported, at 430, in any suitable format, including, but not limited to, a Scalable Vector Graphics (or .SVG) format and/or a Drawing Exchange Format (or .DXF).

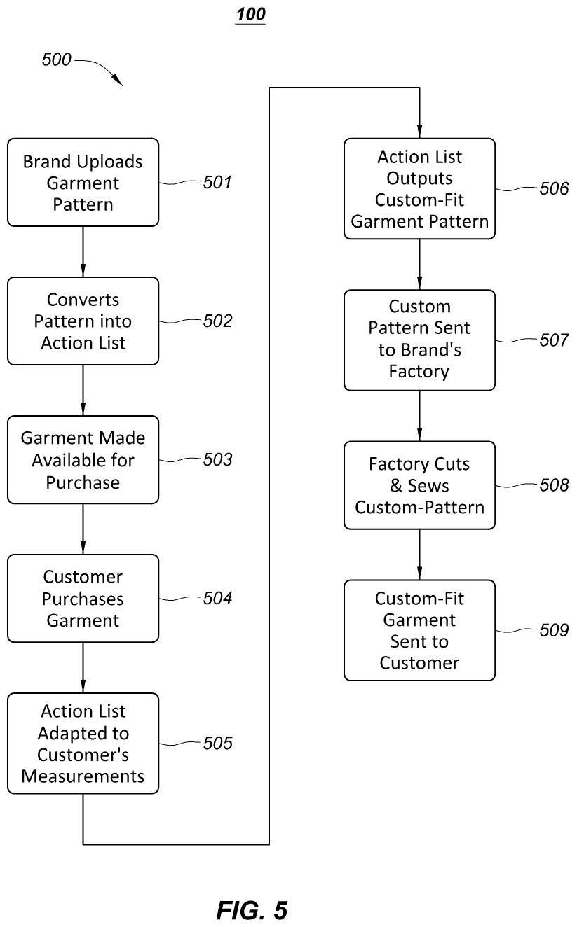

The method 100, for example, can be configured a method 500 for providing custom-fit garments at scale as illustrated in FIG. 5. Turning to FIG. 5, a brand can upload a garment pattern, at 501. The uploaded garment pattern can be converted, at 502, into an action list. An exemplary action list is shown and described in more detail above with reference to FIG. 3D. A garment can be fabricated based upon the uploaded garment pattern and can be made available for purchase, at 503.

At 504, a customer can purchase the available garment. One or more measurements of the customer can be taken. Stated somewhat differently, a body profile can be created for a body of the customer, one or more anthropometric measurements can be made for a three-dimensional body model 200 (shown in FIG. 2) of the customer and/or one or more estimated indirect measurements can be estimated in the manner discussed in more detail above with reference to FIGS. 1-3.

An action list can be adapted to the measurements of the customer, at 505. The action list, at 506, can output a custom-fit garment pattern for the body of the customer in the manner set forth in FIGS. 3D-E. At 507, the outputted custom-fit garment pattern can be provided to a brand for generating a custom-fit garment based upon the outputted custom-fit garment pattern. The brand can utilize the outputted custom-fit garment pattern for creating the custom-fit garment, at 508. In other words, the brand, at 508, can cut and sew fabric or other material based upon the outputted custom-fit garment pattern to create the custom-fit garment. The custom-fit garment then can be sent or otherwise provided to the customer, at 509.

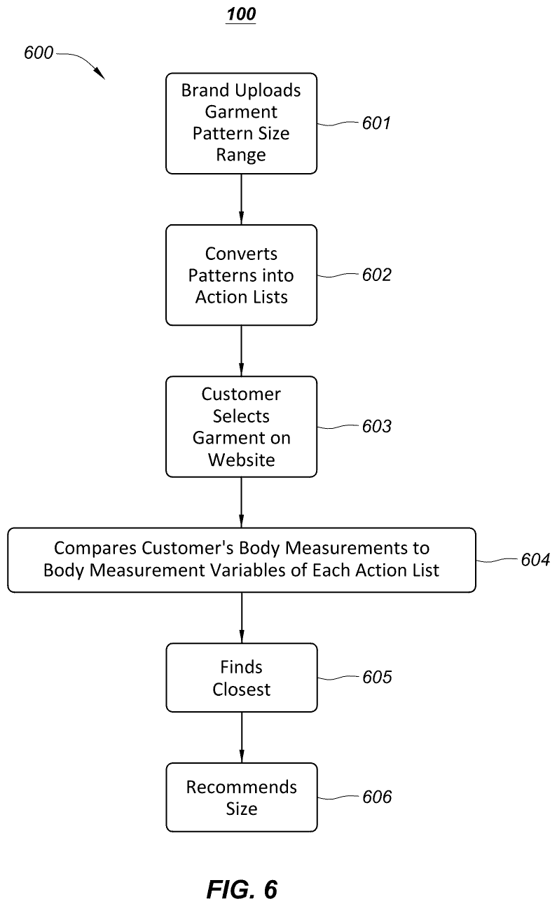

FIG. 6 illustrates an exemplary method 600 for providing a fit guarantee for non-custom-fit garments. Instead of creating one action list that can output a custom-fit pattern for each customer, the method 600 for providing a fit guarantee can enable a brand to create separate action lists for each of their available sizes. The method 600 can compare measurements of a customer to the anthropometric variables in each action list of available sizes and finding which available size is the best match and will fit the customer best. The method 600 advantageously can provide a purely mathematical way to validate fit.

Turning to FIG. 6, the brand can upload, at 601, a predetermined garment pattern in a plurality of different garment sizes. The brand, in other words, can upload the predetermined garment pattern in one or more garment sizes within a selected garment size range. To accommodate the different garment sizes, each uploaded predetermined garment pattern can comprise a different garment pattern such that a plurality of garment patterns can be uploaded, at 601. At 602, the uploaded garment patterns can be converted into action lists. Stated somewhat differently, a separate action list can be created, at 602, for each of the uploaded garment patterns.

A selected garment pattern in a selected garment size can be selected from a listing of garments available from the brand, at 603. The listing of available garments, for example, can be presented on a website associated with the brand. At 604, one or more measurements of the body of the customer can be compared with the anthropometric measurements and/or estimated indirect measurements associated with each of the action lists. In selected embodiments, at least one of the measurements of the body of the customer can be retrieved from a body profile associated with the customer. Based upon the comparison, an uploaded garment pattern with a predetermined garment size can be identified as being a closest match to the body measurements of the customer, at 605. The method 600, at 606, can recommend the identified garment pattern with the predetermined garment size to the customer.

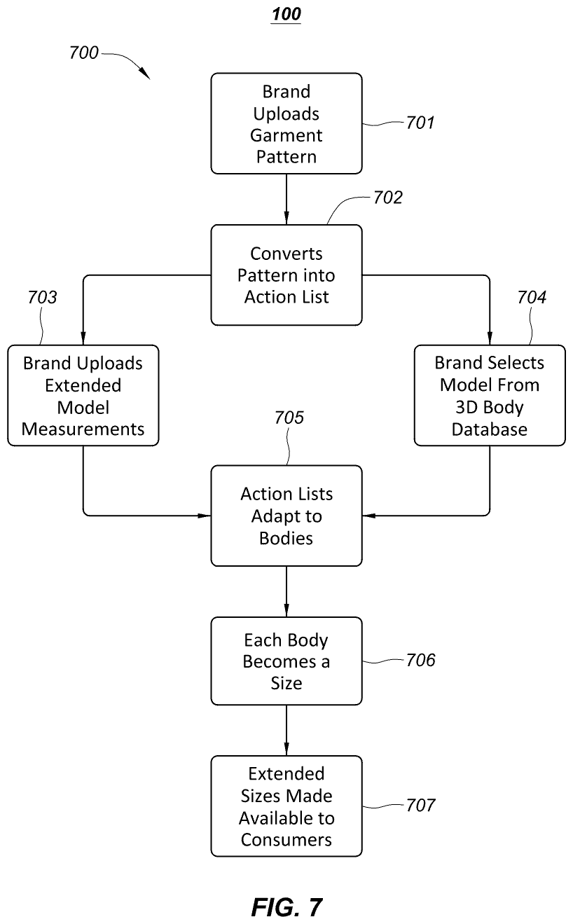

An illustrative method 700 for providing a sized expansion is shown in FIG. 7. The size expansion can create a sized pattern. Turning to FIG. 7, a brand can upload, at 701, a predetermined garment pattern with a selected garment size. The uploaded garment pattern can be converted into an action list, at 702. Based upon the action list, one or more extended model measurements can be uploaded, at 703. Additionally and/or alternatively, one or more models can be selected, at 704, from a plurality of three-dimensional (or 3D) bodies. The selected models can be selected, in selected embodiments, from among three-dimensional bodies stored in a three-dimensional body database.

A plurality of action lists can be generated, at 705. The action lists can be based upon the action list generated from the uploaded garment pattern in combination with the uploaded extended model measurements and/or the selected models. Stated somewhat differently, the plurality of action lists, at 705, can be adapted to bodies associated with the uploaded expanded model measurements and/or the selected models. Each of the bodies associated with the uploaded expanded model measurements and/or the selected models can determine a respective garment size for the uploaded garment pattern, at 706. The uploaded garment pattern, at 707, can be made available in one or more garment sizes other than the selected garment size based upon the bodies associated with the uploaded expanded model measurements and/or the selected models. In other words, the uploaded garment pattern can be made available in an expanded range of garment sizes, which can be made available to customers.

Those skilled in the art will realize that the above recognized advantages and other advantages described herein are merely exemplary and are not meant to be a complete rendering of all of the advantages of the various embodiments set forth in the present disclosure.

Each system (or circuit), as described in the present disclosure or any of its components may be embodied in the form of a processing device (or circuit). The processing device can be, for example, but is not limited to, a general-purpose computer, a smartphone, a programmed microprocessor, a micro-controller, a peripheral integrated circuit element, and other devices or arrangements of devices, which are capable of implementing the steps that constitute the method disclosed herein. The processing device can include a processor, a memory, a non-volatile data storage, a display and/or a user interface.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for generating custom-fit garment patterns at scale, comprising:
creating a three-dimensional body model for a selected custom-fit garment pattern based upon a body profile for a body shape of an intended wearer;
making one or more anthropometric measurements for the three-dimensional body model;
estimating one or more indirect measurements for the three-dimensional body model; and
generating the selected custom-fit garment pattern based upon the body profile with the anthropometric measurements for the three-dimensional body model and the estimated indirect measurements.

2. The method of claim 1, wherein said creating the three-dimensional body model comprises creating a deep learning model for the selected custom-fit garment pattern.

3. The method of claim 2, wherein said creating the three-dimensional body model comprises creating a Skinned Multi-Person Linear (or SMPL) model for the selected custom-fit garment pattern.

4. The method of claim 2, wherein said creating the three-dimensional body model includes:
generating a predetermined number of principal components for reconstructing the body shape of the intended wearer;
determining a body gender of the three-dimensional body model; and
generating a three-dimensional body shape of the three-dimensional body model with at least one set of vertices and edges.

5. The method of claim 4, further comprising disposing the three-dimensional body model in a predetermined body model pose.

6. The method of claim 5, wherein the predetermined body model pose comprises a standard A to T pose.

7. The method of claim 1, wherein said making the one or more anthropometric measurements includes:
defining one or more landmarks on a three-dimensional body shape of the three-dimensional body model;
determining one or more predetermined measurements associated with the three-dimensional body shape based upon the defined landmarks; and
creating a comprehensive body profile for the intended wearer based upon the one or more predetermined measurements.

8. The method of claim 7, wherein said determining the one or more predetermined measurements includes determining a length measurement associated with the three-dimensional body shape, determining a circumference measurement associated with the three-dimensional body shape, determining a shortest path measurement associated with the three-dimensional body shape, or a combination thereof.

9. The method of claim 1, wherein said estimating the one or more indirect measurements includes:
selecting a specific indirect measurement to be estimated;
determining an estimation context for the selected indirect measurement;
identifying at least one of the anthropometric measurements for estimating the selected indirect measurement;
estimating the selected indirect measurement based upon the estimation context and the at least one of the anthropometric measurements; and
adding the estimated indirect measurement to the body profile.

10. The method of claim 9, wherein said estimating the selected indirect measurement comprises estimating the selected indirect measurement via a linear regression model.

11. The method of claim 9, further comprising updating a model registry file associated with the three-dimensional body model to include the estimated indirect measurement.

12. The method of claim 1, wherein said generating the selected custom-fit garment pattern includes:
initializing a structure of the custom-fit garment pattern;
calculating one or more points for the structure of the custom-fit garment pattern;
creating an action list for the one or more calculated points;
dividing one or more lines associated with the structure of the custom-fit garment pattern into at least one line type; and
dividing one or more curves associated with the structure of the custom-fit garment pattern into at least one curve type.

13. The method of claim 12, wherein said calculating the one or more points includes calculating at least one absolute point for the structure of the custom-fit garment pattern, calculating at least one moved point for the structure of the custom-fit garment pattern, calculating at least one free point for the structure of the custom-fit garment pattern, calculating at least one normal foot point for the structure of the custom-fit garment pattern, calculating at least one divide point for the structure of the custom-fit garment pattern, calculating at least one distance point for the structure of the custom-fit garment pattern, or a combination thereof.

14. The method of claim 12,
wherein said dividing the one or more lines comprises dividing the one or more lines associated with the structure of the custom-fit garment pattern into at least one line type based upon the one or more calculated points; and
wherein said dividing the one or more curves comprises dividing the one or more curves associated with the structure of the custom-fit garment pattern into at least one curve type based upon the one or more calculated points.

15. The method of claim 12, wherein said creating the action list comprises creating a series of equations that are configured to output the one or more lines associated with the structure of the custom-fit garment and the one or more curves associated with the structure of the custom-fit garment.

16. The method of claim 15, wherein the series of equations includes at least one variable that comprises a selected anthropometric measurement for the three-dimensional body model.

17. The method of claim 1, further comprising visualizing the generated custom-fit garment pattern.

18. The method of claim 17, wherein said visualizing the generated custom-fit garment pattern includes:
constructing the generated custom-fit garment pattern in two dimensions; and
generating a two-dimensional plot of the constructed custom-fit garment pattern.

19. The method of claim 18, further comprising exporting the constructed custom-fit garment pattern.

20. The method of claim 19, wherein said exporting the constructed custom-fit garment pattern includes exporting the constructed custom-fit garment pattern in a Portable Document Format (or .PDF) format, a Scalable Vector Graphics (or .SVG) format or a Drawing Exchange Format (or .DXF).

21. A computer program product for generating custom-fit garment patterns at scale, the computer program product being encoded on one or more non-transitory machine-readable storage media and comprising:
instruction for creating a three-dimensional body model for a selected custom-fit garment pattern based upon a body profile for a body shape of an intended wearer;
instruction for making one or more anthropometric measurements for the three-dimensional body model;
instruction for estimating one or more indirect measurements for the three-dimensional body model; and
instruction for generating the selected custom-fit garment pattern based upon the body profile with the anthropometric measurements for the three-dimensional body model and the estimated indirect measurements.

22. A system for generating custom-fit garment patterns at scale, comprising:
a processing circuit being configured for:
creating a three-dimensional body model for a selected custom-fit garment pattern based upon a body profile for a body shape of an intended wearer;
making one or more anthropometric measurements for the three-dimensional body model;
estimating one or more indirect measurements for the three-dimensional body model; and
generating the selected custom-fit garment pattern based upon the body profile with the anthropometric measurements for the three-dimensional body model and the estimated indirect measurements.
